(19) United States
(12) Patent Application Publication
(10) Pub. No.: US 2025/0313436 A1
(43) Pub. Date: Oct. 9, 2025

(54) TORQUE STRAP FOR CABLE DRUM SLEEVE

(71) Applicant: Schlumberger Technology Corporation, Sugar Land, TX (US)

(72) Inventors: Ivor Maciver, Aberdeen (GB); Joshua Wurtz, Aberdeen (GB)

(21) Appl. No.: 19/097,951

(22) Filed: Apr. 2, 2025

(30) Foreign Application Priority Data
Apr. 3, 2024 (GB) 2404751.6

(51) Int. Cl. B66D 1/30

(52) U.S. Cl. CPC B66D 1/30

(57) ABSTRACT

A winch reel has a winch drum defining a first radius of curvature. A drum sleeve is affixed to the winch drum, and has an exterior surface defining a second radius of curvature larger than the first radius. At least one torque strap is attached to the winch drum. The torque strap comprises at least one band having length selected to circumferentially traverse the winch drum, and having a band clamp at each longitudinal end. At least one fastener attaches the band clamp at one longitudinal end to a band clamp on an opposed longitudinal end of the at least one band. At least one protrusion extends from a surface of the at least one band, the at least one protrusion shaped to transmit torque to a torque transmitting feature on the drum sleeve.

### CROSS-REFERENCE TO RELATED APPLICATIONS

The current application claims priority to United Kingdom Patent Application No. 2404751.6, filed Apr. 3, 2024, the entirety of which is incorporated by reference.

### BACKGROUND

This disclosure relates to the field of winches used to spool flexible line such as cable and tubing. More particularly, the disclosure relates to apparatus (drum sleeve) used to change a diameter of a drum in a winch reel to increase the minimum bend radius for the cable to be used. It may also improve torque transmission to the spoolable line on the winch drum.

Winches are used to spool and unspool flexible lines such as electrical cables, slickline, wire rope and spoolable tubing for the purpose of moving tools and instruments along wells drilled through the subsurface. Because of the expected depths of some wells, it is not uncommon for the length of such lines stored on typical winch reels to exceed 8,000 meters length. When such length of line is extended into a well, the combined weight of the tools or instruments and the extended line provide considerable tension on the extended line, in particular at the spooling point on the winch reel. FIG. 1 shows an example of deploying an instrument in a subsurface well using a winch unit. A winch unit 12 may be disposed on a platform 11 such as a drilling rig or workover rig. The winch unit 12 may comprise apparatus (not shown separately) to rotate a winch reel 10 disposed on the winch unit 12. The winch reel 10 may have a selected length of spoolable line 13 such as armored electrical cable or tubing encapsulated electrical cable wound thereon and extendable and retractable by operating the winch unit 12. The spoolable line 13 may be attached at its free end to an instrument 20, e.g., an electric submersible pump (ESP) system to be deployed in a subsurface well. A connection 22 between the instrument 20 and the spoolable line 13 may comprise a “weak point”, i.e., a device having a selected breaking strength lower than the breaking strength of the spoolable line 13 to enable cable recovery in the event the instrument 20 becomes stuck in the well so as to make difficult ordinary recovery of the instrument 20 using the winch unit 12. The spoolable line 13 may be reoriented from its spooling orientation off the winch reel 10 by routing the spoolable line 13 through one or more suitably located sheave wheels 18. One of the sheave wheels 18 may be connected to a fixed part of the platform structure (e.g., to a well tubular lifting device or hoist) through a load sensor 16 (“weight indicator”) to apprise the winch unit 12 operator of the tension on the spoolable line 13 during movement of the winch reel 10.

In certain cases, it may be desirable to provide a larger diameter center drum section on an existing winch reel, e.g., a winch reel intended to store a larger length of spoolable line, in order to provide a larger minimum bend radius to the cable or tubing as it is spooled onto the winch reel, or to provide a bottom layer spooling guide for different diameter spoolable lines. A device known for such purpose is referred to as a drum sleeve. Drum sleeves known in the art are formed in two, semicircular segments that may be attached to each other to clamp onto a winch drum. It is desirable to have a device that increases the capacity of the winch reel to transmit torque to the drum sleeve, whereby the spooling capacity of the winch using a drum sleeve is increased.

### SUMMARY

One aspect of the present disclosure is a winch reel. A winch reel according to this aspect has a winch drum defining a first radius of curvature. A drum sleeve is affixed to the winch drum, and has an exterior surface defining a second radius of curvature larger than the first radius. At least one torque strap is attached to the winch drum. The torque strap comprises at least one band having length selected to circumferentially traverse the winch drum, and having a band clamp at each longitudinal end. At least one fastener attaches the band clamp at one longitudinal end to a band clamp on an opposed longitudinal end of the at least one band. At least one protrusion extends from a surface of the at least one band, the at least one protrusion shaped to transmit torque to a torque transmitting feature on the drum sleeve.

In some embodiments, the at least one band comprises a plurality of circumferential segments. The circumferential segments have a combined length selected to circumferentially traverse the winch drum.

In some embodiments, each circumferential segment comprises a band clamp at each longitudinal end.

In some embodiments, each circumferential segment is formed to match a radius of curvature of an exterior surface of the winch drum.

In some embodiments, dimensions and material composition of the at least one band are chosen such that the at least one band is bendable to be affixed to and removed from the winch drum without exceeding an elastic limit.

In some embodiments, the at least one fastener comprises a cap screw and nut.

In some embodiments, the at least one protrusion comprises a lug or block.

In some embodiments, the at least one protrusion is welded to the at least one band.

In some embodiments, the at least one protrusion comprises one of the band clamps.

In some embodiments, the winch drum comprises a flange on one lateral end and a plurality of radially extending ribs disposed proximate the flange. The radially extending ribs comprise the torque transmitting feature.

In some embodiments, a thickness of the radially extending ribs is chosen to space the flange on the drum sleeve a selected distance from a corresponding flange on the winch reel.

In some embodiments, the selected distance and a width of the drum sleeve in combination equals a distance between opposed flanges on the winch reel.

In some embodiments, the winch drum comprises a plurality of laterally spaced apart bulkheads each defining an interior having the first radius of curvature and an exterior coupled to a drum sleeve surface defining the second radius of curvature, and a wall extending transversely to the plurality of bulkheads. The wall comprises the torque transmitting feature.

In some embodiments, the drum sleeve is assembled to the winch drum such that the at least one protrusion contacts the torque transmitting feature in a direction opposed to a direction tension on a cable extended from the winch reel during use.

A method for spooling a spoolable line according to another aspect of this disclosure includes rotating a winch reel to retract the spoolable line onto the winch reel. The winch reel comprises a winch drum defining a first radius of curvature. A drum sleeve is affixed to the winch drum, and has an exterior surface defining a second radius of curvature larger than the first radius of curvature. At least one torque strap is attached to the winch drum, comprising at least one band having length selected to circumferentially traverse a winch drum. The at least one band has a band clamp at each longitudinal end, at least one fastener for attaching the band clamp at one longitudinal end to a band clamp on an opposed longitudinal end of the at least one band and at least one protrusion extending from a surface of the at least one band. The at least one protrusion is shaped to transmit torque to a torque transmitting feature on the drum sleeve.

In some embodiments, the at least one torque strap is attached to the winch drum by opening the at least one band to fit over the winch drum, attaching the at least one fastener, and tightening the at least one fastener until a predetermined clamping force on the band clamp is obtained.

In some embodiments, the drum sleeve is attached to the winch drum such that the at least one protrusion contacts the torque transmitting feature in a direction of rotation of the winch reel.

In some embodiments, the at least one torque strap comprises a plurality of circumferential segments each having a band clamp at each longitudinal end, and wherein the at least one torque strap is attached to the winch drum by disposing each of the plurality of circumferential segments end to and on a surface of the winch drum, inserting at least one fastener into each pair of adjacent band clamps, and tightening each fastener until a predetermined clamping force at each band clamp is obtained.

In some embodiments, the drum sleeve is attached to the winch drum by applying each of a plurality of circumferential segments of the drum sleeve on a surface of the winch drum at a selected lateral position, and attaching at least one link between adjacent circumferential ends of each circumferential segment.

Other aspects and possible advantages will be apparent from the description and claims that follow.

### BRIEF DESCRIPTION OF THE DRAWINGS

FIG. 1 shows a known system used to convey instruments into a subsurface well using spoolable line such as armored electrical cable.

FIG. 2 shows an oblique view of a winch reel used in the winch shown in FIG. 1, wherein a torque strap according to the present disclosure is attached to a drum section of the reel.

FIG. 3 shows an oblique view of a winch reel used in the winch shown in FIG. 1, wherein a torque strap according to the present disclosure is attached to a drum section of the reel, and onto which a circumferential segment of a drum sleeve is installed onto the winch drum.

FIG. 4 shows an enlarged view of part of the winch drum, drum sleeve and torque strap to illustrate interaction between a protrusion on the torque strap and a radial rib on the drum sleeve for torque transmission.

FIG. 5 shows a sectional view of the drum sleeve, torque strap and protrusions to illustrate interaction between the protrusions and the drum sleeve to transmit torque.

FIGS. 5A and 5B show various views of a drum sleeve as described with reference to FIG. 3 and FIG. 4.

FIG. 6 shows an example embodiment of a torque strap according to the present disclosure.

FIG. 7 shows an enlarged view of a protrusion on the surface of the torque strap.

FIG. 8 shows an example embodiment of a clamp used to affix the torque sleeve to the winch drum.

### DETAILED DESCRIPTION

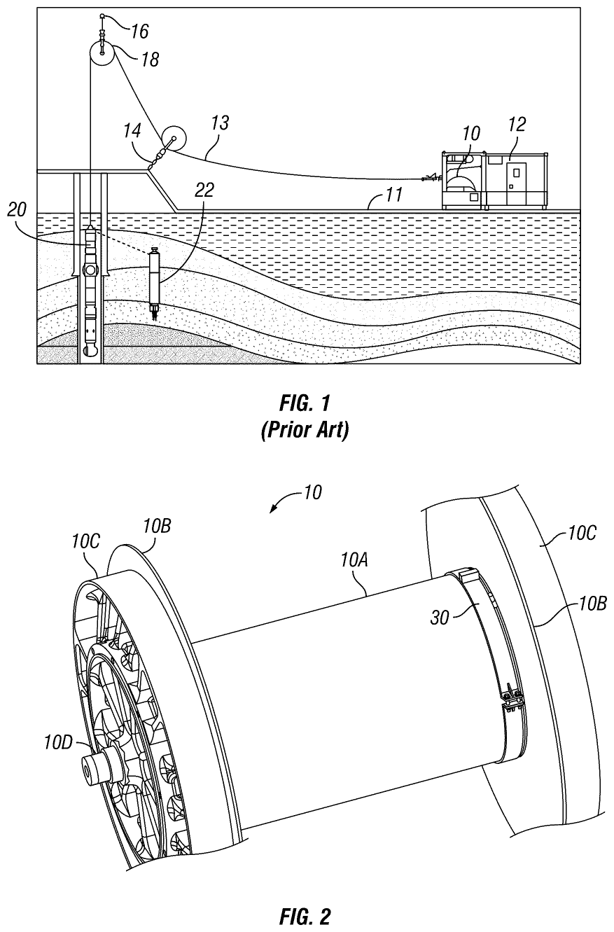

FIG. 2 shows an oblique view of a winch reel 10 having affixed thereto a drum 10A thereof an example embodiment of a torque strap 30 according to the present disclosure. The winch reel 10 may comprise a cylindrical winch drum 10A onto which a spoolable line, such as electrical cable, slickline, wire rope or tubing may be wound and unwound as explained with reference to FIG. 1. The winch reel 10 may comprise laterally spaced apart flanges 10B to constrain the area onto which such spoolable line may be wound. One or more brake surfaces 10C may each be disposed adjacent to one of the flanges 10B to enable engagement of a brake, such as a band brake or disk brake caliper (not shown) to resist and/or stop rotation of the winch reel 10 when and as the winch unit (12 in FIG. 1) operator so desires. The winch reel 10 may be rotatably supported in bearings (not shown) in the winch unit (12 in FIG. 1) by respective, laterally extending spindles 10C.

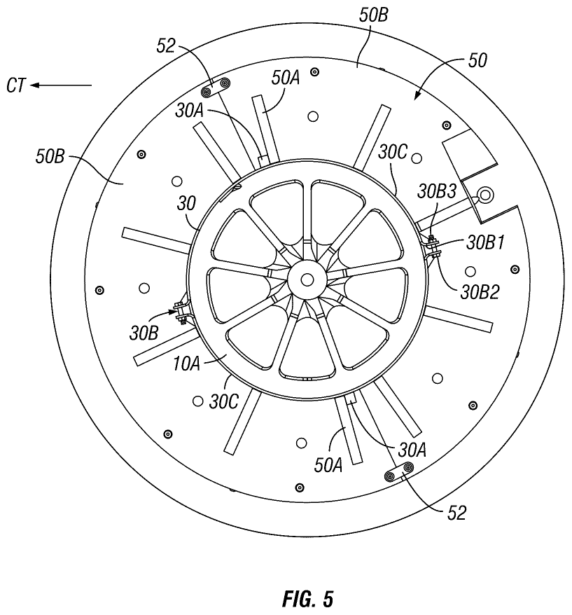

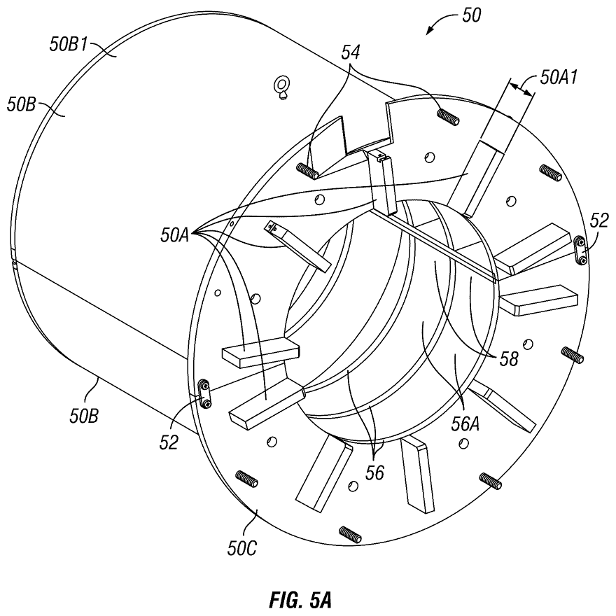

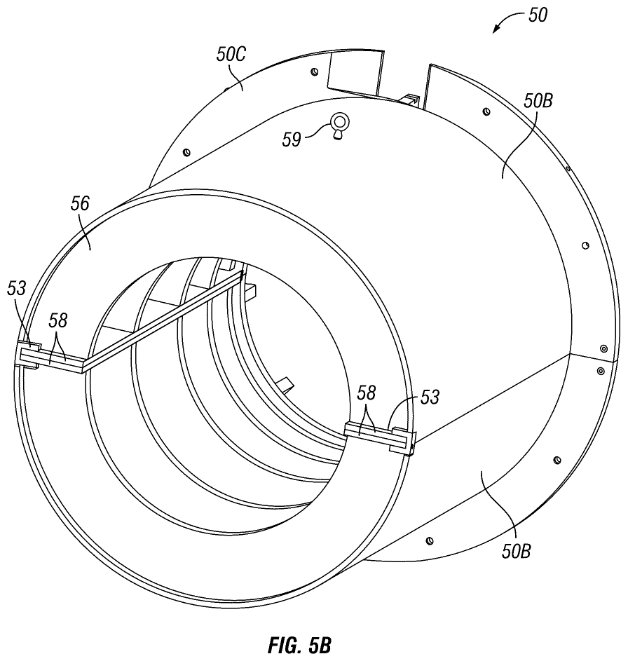

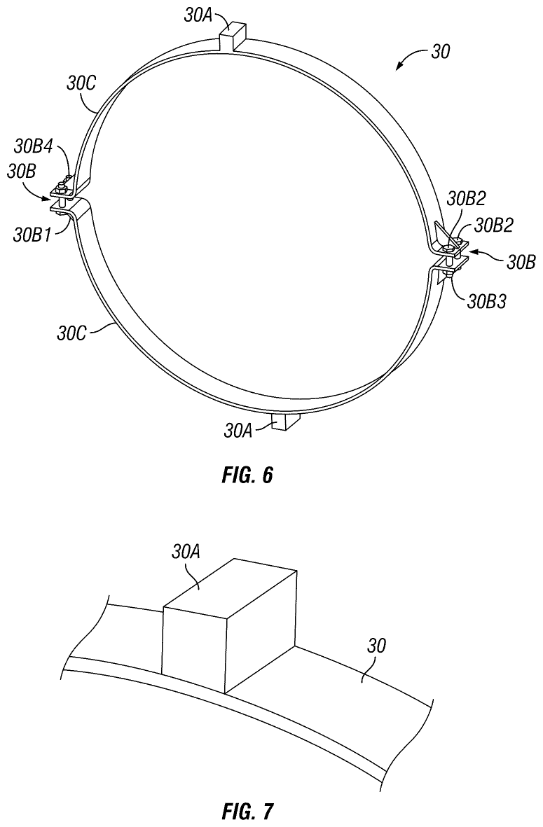

A torque strap 30 may be affixed to the winch drum 10A as will be further explained below. While FIG. 2 shows only one such torque strap 30 disposed at a selected lateral position on the winch drum 10A, in some embodiments more than one such torque strap may be affixed to the winch drum 10A at laterally spaced apart locations on the winch drum 10A. The number of and lateral locations of such torque strap(s) are not limitations on the scope of the present disclosure. The torque strap 30 may be attached to the winch drum 10A with such (clamping) force so as to resist rotation with respect to the winch drum 10A when substantial torque is applied to the winch reel 10 during winch unit (12 in FIG. 1) operation. In some embodiments, the torque strap 30 may be in the form of at least one band 30E having thickness substantially smaller than the width of the band 30E, whereby the band 30E may be sufficiently flexible to be able to be urged to conform to the exterior surface of the winch drum 10A. The width of the band 30E may be chosen to provide sufficient frictional engagement with the winch drum 10A to resist slipping under expected torque loads, while thin enough not to interfere with mounting a drum sleeve (described in more detail below). The torque strap 30 may be made from steel or similar high strength, flexible material. The dimensions of and the material composition of the band(s) 30E may be chosen such that deformation during attachment to and detachment from the winch drum 10A is within the elastic limit of the band 30E structure. In some embodiments, the material and dimensions need not provide substantial flexibility, for example, when the torque strap is assembled from two or more circumferential segments (see FIGS. 5 and 6). In some embodiments, the dimensions of the torque strap bands 30E may be chosen such that once formed to conform to the external diameter of the winch drum 10A, the torque strap bands 30E may remain in such shape whether affixed to the winch drum 10A or not.

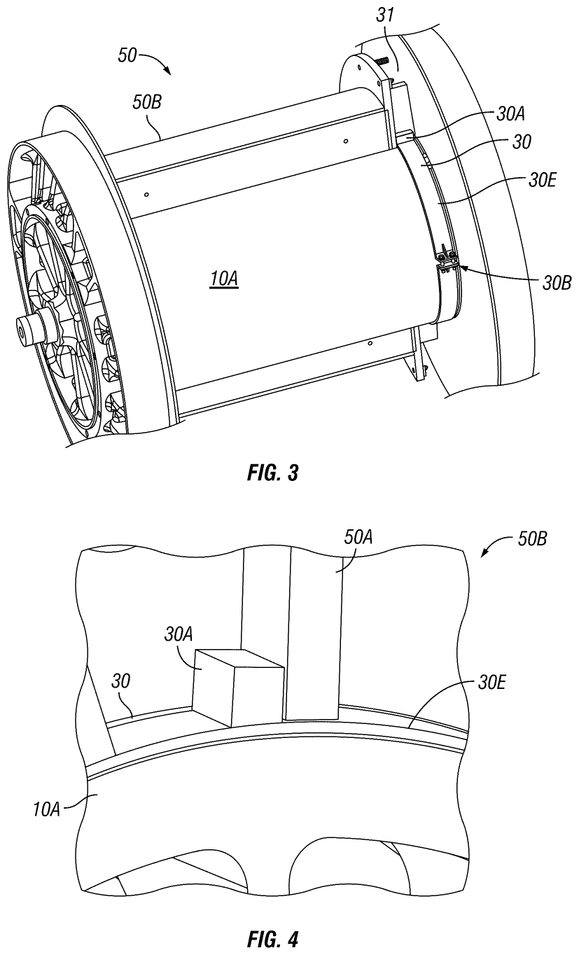

FIG. 3 shows the view of FIG. 2 with the addition of a circumferential segment 50B of a drum sleeve 50 disposed onto the winch drum 10A. The circumferential segment 50B may form one of two or more such circumferential segments of the drum sleeve 50 such that assembly of a plurality of such circumferential segments 50B to each other and/or to the winch drum 10A will form the complete drum sleeve 50. The drum sleeve 50 (see FIG. 4 for an embodiment of the drum sleeve 50 consisting of two such circumferential segments 50B) may include features, to be explained further below, to engage one or more protrusions 30A extending from the surface of the torque strap band(s) 30B. The one or more protrusions 30A may be in the form of rectangular blocks or lugs as shown, or may be in any other shape that can transmit torque between the torque strap 30 and the drum sleeve 50. In some embodiments, the one or more protrusions 30A may be affixed to the surface of the at least one band 30B by welding, although the manner of affixing is not a limit on the scope of the present disclosure. The drum sleeve 50 may comprise one or more radially extending ribs

As shown in FIG. 4, the drum sleeve circumferential segment 50B may comprise one or more radially extending ribs 50A on the exterior lateral surface (flange) of the drum sleeve 50 to enable transmission of torque between the one or more protrusions 30A and the drum sleeve 50. The location of and shape of any torque transmitting feature on the drum sleeve 50 is not a limit on the scope of the present disclosure. It is only necessary for the torque transmitting feature(s) on the drum sleeve 50 to cooperate with the protrusion(s) 30A on the torque strap 30 to transmit torque between the torque strap 30 and the drum sleeve 50.

A sectional view of the drum sleeve 50 affixed to the winch drum 10A is shown in FIG. 5. The parts 50B of the drum sleeve 50 may be coupled together to affix the drum sleeve 50 to the winch drum 10A, using, for example, links 52 on the lateral sides of the drum sleeve 50 that connect the parts 50B to each other proximate to where the parts 50B are adjacent to each other. The torque strap 30, as will be shown in more detail in FIG. 6, may be assembled to the winch drum 10A by coupling together two or more circumferential band segments 30C using one or more band clamps 30B. Each such band segment 30C may comprise on its longitudinal ends part of one of the band clamps 30B, which when joined to a band clamp part on an adjacent strap segment 30C couples the circumferential strap segments 30C to each other, and ultimately completes the torque strap assembly to the winch drum 10A. In some embodiments, in which there is only one band (e.g., 30E in FIG. 3), the band clamp 30B may comprise featured disposed at each circumferential end of the band as shown in FIG. 6. Each band clamp 30B may comprise a clamp flange 30B1 extending outward from the band 30B surface of the torque strap 30. Opposed clamp flanges 30B1 may be coupled to each other using cap screws 30B2 and nuts 30B3. During assembly, the nuts 30B3 may be tightened such that the torque strap 30 when fully assembled frictionally engages the surface of the winch drum 10A sufficiently to transmit the largest expected torque between the winch drum 10A and the drum sleeve 30.

The radially extending ribs 50A may engage the one or more protrusions 30A such that torque exerted by the winch reel 10 counter to the tension CT on the medium (e.g., cable or tubing) will be transmitted between the winch drum 10A and the drum sleeve (50 in FIG. 3), thereby ultimately to the spoolable line (not shown).

FIGS. 5A and 5B show opposed oblique views of the drum sleeve 50 to better illustrate some of the features. The present example embodiment of the drum sleeve 50 may comprise two (or more) circumferential segments 50B to engage the exterior surface of the winch drum (10A in FIG. 2). The circumferential segments 50B each may comprise an outer surface 50B1 having a diameter larger than an external diameter of the winch drum (10A in FIG. 1), and an internal diameter defined by a plurality of spaced apart bulkheads 56 traversing the interior of the drum sleeve segments 50B. An inner radius of curvature of the bulkheads 56 may be chosen to match the curvature of the winch drum (10A in FIG. 2) such that when the circumferential segments 50B are attached to the winch drum (10A in FIG. 2) they fit tightly to the winch drum (10A in FIG. 1). It will be appreciated that spaces 56A between adjacent bulkheads 56 may enable affixing additional torque straps (30 in FIG. 3) to the winch drum (10A in FIG. 2) such that the protrusions associated therewith may be disposed in one of the spaces 56A. Further, the protrusions may be circumferentially disposed such that they contact a wall 58 on the parting line of the circumferential ends of each circumferential segment 50B such that the protrusion(s) cooperate with the respective wall 58 to transmit torque between the torque strap 30 and the drum sleeve 50.

In some embodiments, the drum sleeve 50 may comprise a flange 50C on one or both sides. The embodiment shown in FIG. 5A may comprise only one such flange 50C, wherein the drum sleeve 50 may be laterally spaced from the corresponding flange (10B in FIG. 2) on the winch reel (10 in FIG. 2) to provide, e.g., a transition area (see 31 in FIG. 3) for spooling line disposed between the flange 50C on the drum sleeve 50. In some embodiments, the winch reel flange (10B in FIG. 2) on the opposed side of the drum sleeve flange 50C may serve to limit the spooling area as explained with reference to FIG. 2. In some embodiments, a width of the transition area (31 in FIG. 3) may be determined by inserting one or more spacer pins 54 in the flange 50C. In some embodiments, the width of the transition area (31 in FIG. 3) may be determined by a thickness 50A1 of the radially extending ribs 50A. The radially extending ribs 50A may also provide a spooling surface in the transition area (31 in FIG. 3).

FIG. 5B shows an opposed oblique view to that of FIG. 5A to illustrate additional features of an example embodiment of the drum sleeve 50. The walls 58 on the circumferential ends of each circumferential segment 50B may extend outward from the outermost bulkhead 56 to enable attachment of a retaining clip 53 across two adjacent walls 58. The retaining clips 53 may reduce risk of separation of the circumferential segments 50B before any spoolable line is wound around the drum sleeve 50.

In some embodiments, a lifting eye 59 may be attached to each circumferential segment to facilitate assembling the drum sleeve 50 to the winch drum (10A in FIG. 3).

FIG. 6 shows an example embodiment of the torque strap 30 by itself to better illustrate some of its features. As explained above, the torque strap 30 may comprise two or more circumferential segments 30C. The present example embodiment shows two such circumferential segments 30C, however the number of segments is not a limit on the scope of the present disclosure, and as previously explained one single band may be used in some embodiments. It will be appreciated that to assemble the torque strap 30 to the winch drum (10A in FIG. 2) it is only necessary to have the torque strap 30 be able to be separated at one position along its circumference in order to move it over the winch drum (10A in FIG. 2). The example embodiment in FIG. 6 includes two band clamps 30B, each of which comprises a pair of flanges 30B1, each flange of which may be reinforced by a plate 30B4 transversely joining the respective flange 30B1 to the main body (band) of the circumferential segment 30C. Cap screws 30B2 and nuts 30B3 may provide the required clamping force to attach the circumferential segments 30C to each other and to cause the torque strap 30 to frictionally engage the winch drum (10A in FIG. 2). Each circumferential segment 30C may comprise one or more protrusions 30A of shape and attachment as explained with reference to FIGS. 3 and 4.

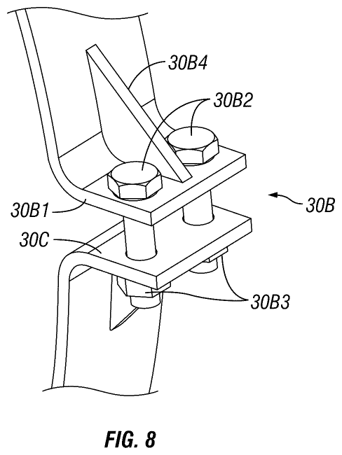

FIG. 7 shows more detail of an example embodiment of one of the protrusions 30A attached to the torque strap 30. FIG. 8 shows the flanges 30B1, cap screws 30B2, nuts 30B3 and reinforcements 30B4 for one of the band clamps 30B in more detail. It will be appreciated that in some embodiments, the torque strap 30 may comprise a single band, separated in only one place, whereby coupling longitudinal ends of the single band together, e.g., using a band clamp as shown in FIG. 8 will attach the torque strap to the winch drum (10A in FIG. 2). Having the torque strap 30 in the form of two or more circumferential segments may be more convenient for attachment and removal of the torque strap 30 than a single band covering the entire winch drum circumference.

In some embodiments, the one or more protrusions 30A may form part of or all of the band clamps, e.g., by affixing a block to one longitudinal end of one of the bands 30E or band segments and extending bolts through a clamp flange as explained with reference to FIG. 6. In some embodiments, such blocks may be applied to each longitudinal and one of the blocks being adjacent to another formed (e.g., threaded) to accept bolts from the adjacent block.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

1. A winch reel, comprising:
a reel having a winch drum defining a first radius of curvature;
a drum sleeve affixed to the winch drum, the drum sleeve having an exterior surface defining a second radius of curvature larger than the first radius of curvature; and
at least one torque strap attached to the winch drum, the at least one torque strap, comprising at least one band having length selected to circumferentially traverse a winch drum, the at least one band having a band clamp at each longitudinal end, at least one fastener for attaching the band clamp at one longitudinal end to a band clamp on an opposed longitudinal end of the at least one band and at least one protrusion extending from a surface of the at least one band, the at least one protrusion shaped to transmit torque to a torque transmitting feature on the drum sleeve.

2. The winch reel of claim 1 wherein the at least one band comprises a plurality of circumferential segments, the circumferential segments having a combined length selected to circumferentially traverse the winch drum.

3. The winch reel of claim 2 wherein each circumferential segment comprises a band clamp at each longitudinal end.

4. The winch reel of claim 2 wherein each circumferential segment is formed to match a radius of curvature of an exterior surface of the winch drum.

5. The winch reel of claim 1 wherein dimensions and material composition of the at least one band are chosen such that the at least one band is bendable to be affixed to and removed from the winch drum without exceeding an elastic limit.

6. The winch reel of claim 1 wherein the at least one fastener comprises a cap screw and nut.

7. The winch reel of claim 1 wherein the at least one protrusion comprises a lug or block.

8. The winch reel of claim 1 wherein the at least one protrusion is welded to the at least one band.

9. The winch reel of claim 1 wherein the at least one protrusion comprises one of the band clamps.

10. The winch reel of claim 1 wherein the winch drum comprises a flange on one lateral end and a plurality of radially extending ribs disposed proximate the flange, the radially extending ribs comprising the torque transmitting feature.

11. The winch reel of claim 10 wherein a thickness of the radially extending ribs is chosen to space the flange on the drum sleeve a selected distance from a corresponding flange on the winch reel.

12. The winch reel of claim 11 wherein the selected distance and a width of the drum sleeve in combination equals a distance between opposed flanges on the winch reel.

13. The winch reel of claim 1 wherein the winch drum comprises a plurality of laterally spaced apart bulkheads each defining an interior having the first radius of curvature and an exterior coupled to a drum sleeve surface defining the second radius of curvature, and a wall extending transversely to the plurality of bulkheads, the wall comprising the torque transmitting feature.

14. The winch reel of claim 13 wherein the drum sleeve is assembled to the winch drum such that the at least one protrusion contacts the torque transmitting feature in a direction opposed to a direction tension on a cable extended from the winch reel during use.

15. A method for spooling a spoolable line, comprising:
rotating a winch reel to retract the spoolable line onto the winch reel, the winch reel comprising a winch drum defining a first radius of curvature, a drum sleeve affixed to the winch drum, the drum sleeve having an exterior surface defining a second radius of curvature larger than the first radius of curvature and at least one torque strap attached to the winch drum, the at least one torque strap comprising at least one band having length selected to circumferentially traverse a winch drum, the at least one band having a band clamp at each longitudinal end, at least one fastener for attaching the band clamp at one longitudinal end to a band clamp on an opposed longitudinal end of the at least one band and at least one protrusion extending from a surface of the at least one band, the at least one protrusion shaped to transmit torque to a torque transmitting feature on the drum sleeve.

16. The method of claim 15 wherein the at least one torque strap is attached to the winch drum by opening the at least one band to fit over the winch drum, attaching the at least one fastener, and tightening the at least one fastener until a predetermined clamping force on the band clamp is obtained.

17. The method of claim 15 wherein the drum sleeve is attached to the winch drum such that the at least one protrusion contacts the torque transmitting feature in a direction of rotation of the winch reel.

18. The method of claim 15 wherein the at least one torque strap comprises a plurality of circumferential segments each having a band clamp at each longitudinal end, and wherein the at least one torque strap is attached to the winch drum by disposing each of the plurality of circumferential segments end to and on a surface of the winch drum, inserting at least one fastener into each pair of adjacent band clamps, and tightening each fastener until a predetermined clamping force at each band clamp is obtained.

19. The method of claim 15 wherein the drum sleeve is attached to the winch drum by applying each of a plurality of circumferential segments of the drum sleeve on a surface of the winch drum at a selected lateral position, and attaching at least one link between adjacent circumferential ends of each circumferential segment.
